(19) United States
(12) Patent Application Publication
(10) Pub. No.: US 2026/0260279 A1
(43) Pub. Date: Sep. 3, 2026

(54) SYSTEM

(71) Applicant: SOFTBANK GROUP CORP., Tokyo (JP)

(72) Inventor: Takamasa TOYAMA, Tokyo (JP)

(73) Assignee: SOFTBANK GROUP CORP., Tokyo (JP)

(21) Appl. No.: 19/554,769

(22) Filed: Mar. 3, 2026

Related U.S. Application Data
(60) Provisional application No. 63/766,349, filed on Mar. 3, 2025.

(51) Int. Cl. G06Q 30/0601; G06N 3/0475; G06N 3/096; G06Q 20/38

(52) U.S. Cl. CPC G06Q 30/0631; G06N 3/0475; G06N 3/096; G06Q 20/382

(57) ABSTRACT

A system that provides an efficient and personalized experience when a user purchases a product is disclosed. The user inputs information about the product via a device, and the generative AI unit analyzes this information and decomposes it into product attributes. The analyzed information is used by the search unit to search the product database and identify products matching the conditions. Furthermore, the review generation unit generates a review summary for the product and presents it to the user, facilitating comparison and consideration of the product. The selected product is ordered via an interactive interface through the order processing unit, completing the purchase procedure. This system aims to enhance the user's purchasing experience and streamline the decision-making process in online shopping.

### CROSS-REFERENCE TO RELATED APPLICATION

This application claims priority under 35 U.S.C. § 119 to U.S. Provisional Patent Application No. 63/766,349, filed on March 3, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for reducing the information overload and difficulty of choice users face when purchasing products, thereby providing a more efficient and personalized purchasing experience is provided. In conventional online shopping, users had to spend considerable time and effort finding products matching their needs from vast amounts of product information. Furthermore, individually checking product reviews and ratings often burdens users. The disclosure utilizes generative AI to analyze user input and perform searches based on product attributes, enabling the rapid identification of products matching user preferences. Furthermore, by automatically generating review summaries, users can easily grasp a product's features, advantages, and disadvantages, facilitating comparison and consideration. This allows users to select the optimal product with less effort and complete the purchase process smoothly. In this way, it aims to enhance the user's shopping experience while also streamlining the decision-making process in online shopping.

The means to solve the problem is to provide a system comprising: a generative AI unit that receives product-related information from the user, analyzes that information, and performs product searches; a search unit that searches a product database based on the analyzed information and identifies matching products; a review generation unit that generates product reviews based on the search results and presents them to the user; and an order processing unit that provides an interactive interface for ordering the product selected by the user.

The generative AI unit analyzes information input by the user, such as product name, origin, manufacturer, and budget, using natural language processing technology to decompose it into product attributes. This enables the extraction of attributes such as product category, origin, price range, and brand, allowing the unit to collaborate with the search unit to quickly identify products matching the user's needs. Furthermore, the review generation unit creates review summaries based on past user reviews and product features, including key characteristics, advantages, and disadvantages. Presenting these to users facilitates product comparison and evaluation. The order processing unit provides an interactive interface to confirm details of the selected product, respond to additional questions, and perform final order confirmation, enabling a smooth purchasing process. In this way, it enhances the user's purchasing experience and streamlines the decision-making process in online shopping.

### BRIEF DESCRIPTION OF THE DRAWINGS

FIG. 1 is a conceptual diagram showing an example configuration of the data processing system according to the first embodiment.

FIG. 2 is a conceptual diagram showing an example of key functional components of the data processing device and smart device according to the first embodiment.

FIG. 3 is a conceptual diagram showing an example configuration of a data processing system according to a second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface that includes a communication processor and an antenna, among other components. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" may mean only A, only B, or a combination of A and B. Furthermore, in this specification, when three or more items are connected using "and/or," the same concept applies as for "A and/or B".

### First Embodiment

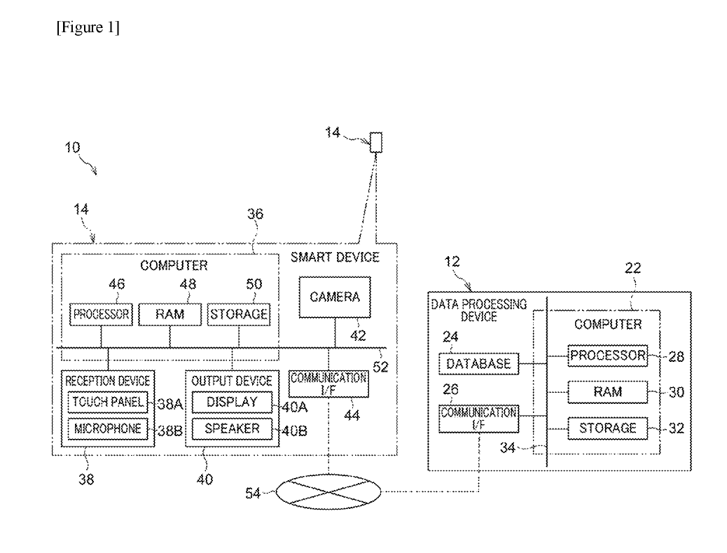

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, presenting data to user 20 by outputting it in a perceptible form (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

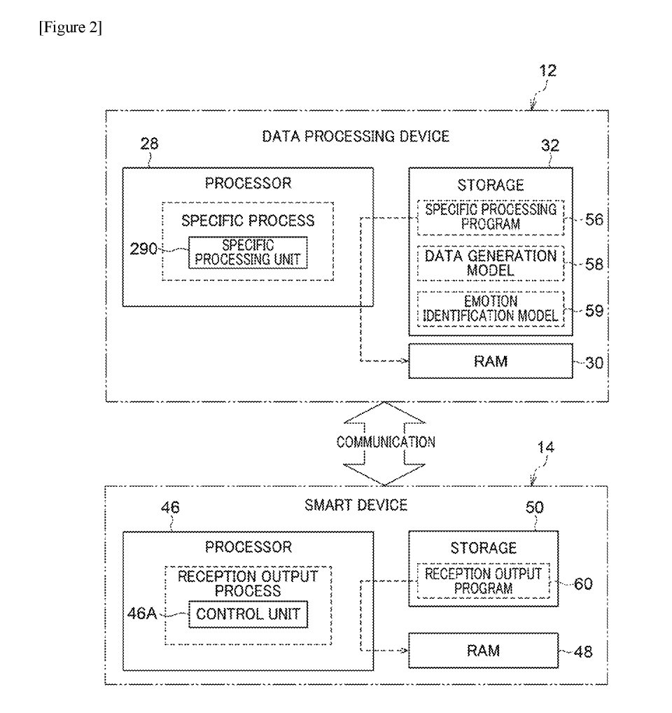

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

As an embodiment for implementing the present invention, a system configuration using a user terminal and a server is described in detail. This system aims to provide an efficient and personalized experience when a user purchases a product.

First, the user terminal is a device such as a smartphone, tablet, or personal computer and serves to provide a user interface. This interface is provided via a web browser or a dedicated application. The user inputs information about the desired product using a form displayed on the terminal's screen. Specifically, the user can input the product name, place of origin, manufacturer, budget, desired functions or features (e.g., waterproof performance or high-resolution display), and so forth. This enables the user to convey their needs to the system in detail.

Next, the information sent from the user terminal is transmitted to a server via the internet. The server is located in a cloud environment and possesses advanced computational capabilities. A generative AI unit is installed within the server to analyze the received information. This generative AI unit uses natural language processing technology to decompose the user's input into product attributes. For example, the category is extracted from the product name "smartphone," regional characteristics from the origin "Made in Japan," and the price range from the budget "within ¥50,000." Additionally, the desired functions and features entered by the user are also analyzed and considered as important factors in product selection.

The analyzed information is sent to the search unit within the server. This search unit possesses a vast product database and identifies products matching the user's criteria. The database stores detailed information on various products. For example, for smartphones, this includes model name, manufacturer, specifications (processor, memory, storage capacity), price, user reviews, and rating scores. The search unit can rapidly narrow down relevant products based on specified price ranges, origin, and desired features. Furthermore, search results are presented as personalized recommendations, taking into account the user's past purchase history and browsing history.

Search results are sent to the server's review generation unit. This unit generates a review summary for the product based on past user reviews and the product's features. The review generation unit uses machine learning algorithms to automatically extract a product's advantages and disadvantages, presenting them in a user-friendly format. For example, reviews for a smartphone might include features such as "long battery life," "excellent camera performance," and "stylish design." This allows users to easily grasp a product's strengths and weaknesses, facilitating comparison and evaluation.

The generated reviews are sent to the user's device and presented to them. Users can compare products based on the presented information and make selections. For selected products, the ordering process proceeds through an interactive interface on the user's device. This interface uses chatbots or voice assistants to enable natural conversation with the user. Users can verify detailed product information and ask additional questions. For example, the system provides appropriate responses to questions such as "What is the warranty period for this product?", "How long does delivery take?", and "What payment methods are available?"

Finally, when the user confirms the order, the server completes the purchase procedure and sends a confirmation email to the user. This email includes the order details, estimated delivery date, payment information, etc. Additionally, the user can view their order history on their device and track the delivery status. In this way, the present invention enhances the user's purchasing experience while streamlining the decision-making process in online shopping.

### System Configuration

The system according to this embodiment comprises a user interface unit, a generative AI unit, a search unit, a review generation unit, and an order processing unit. The user interface unit provides an interface for users to input information about products. Specifically, it operates on devices such as smartphones, tablets, or PCs, displaying a form via a web browser or dedicated application for inputting product name, origin, manufacturer, budget, and desired functions or features. For example, if a user is seeking a "smartphone made in Japan for under ¥50,000," inputting this information allows them to convey specific needs to the system. Furthermore, the user interface unit is designed to support voice input and gesture operation, enabling intuitive user interaction.

The Generative AI component analyzes information sent from the User Interface component. Located on the server, it uses advanced natural language processing technology to decompose user input into product attributes. For example, it extracts the category from the product name "smartphone," regional characteristics from the origin "made in Japan," and the price range from the budget "under ¥50,000." Furthermore, desired functions or features entered by the user are also analyzed and considered as important factors in product selection. A specific example of a prompt sentence fed to the generative AI unit is: "Based on the information entered by the user, extract the product category, origin, price range, brand, and desired functions, and decompose them into product attributes."

The search unit searches the product database based on information analyzed by the generative AI unit. This unit possesses a vast product database and identifies products matching the user's criteria. The database stores detailed information on various products; for example, for smartphones, this includes model name, manufacturer, specifications (processor, memory, storage capacity), price, user reviews, and rating scores. The search unit can rapidly narrow down relevant products based on specified price ranges, place of origin, and desired features. Furthermore, search results are presented as personalized recommendations, taking into account the user's past purchase history and browsing history.

The review generation unit generates reviews for products identified by the search unit. This unit creates a review summary based on past user reviews and the product's features. The review generation unit uses machine learning algorithms to automatically extract a product's advantages and disadvantages and present them in a user-friendly format. For example, for a smartphone, features such as "long battery life," "excellent camera performance," and "stylish design" are included in the review. This allows users to easily grasp a product's strengths and weaknesses, facilitating comparison and consideration.

The order processing unit provides an interactive interface for users to place orders for selected products. This interface enables natural conversation with users through chatbots or voice assistants. Users can verify product details and ask additional questions. For example, the system provides appropriate responses to queries like "What is the warranty period for this product?", "How long will delivery take?", or "What payment methods are available?". Finally, when the user confirms the order, the order processing unit completes the purchase procedure and sends a confirmation email to the user. This email includes the order details, estimated delivery date, payment information, etc. Additionally, the user can view their order history on their device and track the delivery status. In this way, the system according to this embodiment enhances the user's purchasing experience and streamlines the decision-making process in online shopping.

### Implementation Steps

### Step 1: User Information Input

The user inputs information about the product using a device such as a smartphone, tablet, or personal computer via a web browser or dedicated application. Specifically, a form is displayed for entering the product name, place of origin, manufacturer, budget, and desired functions or features. For example, if a user is searching for a "smartphone made in Japan for under 50,000 yen," entering this information allows them to communicate their specific needs to the system. The user interface is designed to support voice input and gesture controls, enabling intuitive operation.

### Step 2: Information Analysis

The information submitted by the user is sent to the server and analyzed by the generative AI unit. This unit uses advanced natural language processing technology to decompose the user's input into product attributes. For example, the product name "smartphone" yields the category, the origin "made in Japan" yields the regional characteristic, and the budget "under ¥50,000" yields the price range. Furthermore, the desired functions and features entered by the user are also analyzed and considered as important factors in product selection. A specific example of a prompt fed to the generative AI is: "Based on the information entered by the user, extract the product category, origin, price range, brand, and desired features, and decompose them into product attributes."

### Step 3: Product Search

The analyzed information is sent to the search unit within the server to query the product database. This unit possesses a vast product database and identifies products matching the user's criteria. The database stores detailed information on various products; for example, for smartphones, this includes model name, manufacturer, specifications (processor, memory, storage capacity), price, user reviews, and rating scores. The search unit can rapidly narrow down relevant products based on specified price ranges, place of origin, and desired features. Furthermore, search results are presented as personalized recommended products, taking into account the user's past purchase history and browsing history.

### Step 4: Review Generation

Reviews for products identified by the search component are generated by the review generation component. This component generates a review summary based on past user reviews and the product's features. The review generation unit uses machine learning algorithms to automatically extract a product's advantages and disadvantages, presenting them in a user-friendly format. For example, reviews for a smartphone might include features such as "long battery life," "excellent camera performance," and "stylish design." This allows users to easily grasp a product's strengths and weaknesses, facilitating comparison and evaluation.

### Step 5: Order Processing

An interactive interface is provided for the user to order the selected product. This interface enables natural conversation with the user using chatbots or voice assistants. The user can confirm product details and ask additional questions. For example, the system provides appropriate responses to questions like "What is the warranty period for this product?" or "How long does shipping take?" or "What payment methods are available?" The system provides appropriate responses to these questions. Finally, when the user confirms the order, the order processing unit completes the purchase procedure and sends a confirmation email to the user. This email includes the order details, estimated delivery date, payment information, etc. Additionally, the user can view their order history on their device and track the delivery status.

### (Specific Use Cases)

For example, when a user wants to purchase a new laptop, they first access the user interface via a smartphone or computer browser, or a dedicated application. Here, the user inputs specific information about the desired laptop. Input fields include: "Laptop" as the product name, "Domestically manufactured" as the desired place of origin, "Specific brand" as the manufacturer, "Within ¥100,000" as the budget, and desired features such as "Lightweight," "Long battery life," and "High-resolution display."

Once the user inputs the information, it is sent to the server and analyzed by the generative AI unit. The generative AI unit uses natural language processing technology to decompose the input information into product attributes. For example, it extracts "laptop" as the product category, "domestic" as the origin, "under ¥100,000" as the price range, "specific brand" as the brand, and "lightweight," "long battery life," and "high-resolution display" as the desired features. A specific example of a prompt sentence fed to the generative AI is: "Based on the notebook computer information entered by the user, extract the product category, place of origin, price range, brand, and desired features, and decompose them into product attributes."

The analyzed information is sent to the search unit to query the product database. The database stores detailed information on various notebook PCs, including model name, manufacturer, specifications (processor, memory, storage capacity), price, user reviews, and rating scores. The search unit can quickly narrow down matching notebook computers based on the specified conditions. Furthermore, the search results are presented as personalized recommended products, taking into account the user's past purchase history and browsing history.

For the notebook computers obtained as search results, the review generation unit generates a review summary. This unit automatically extracts the product's advantages and disadvantages based on past user reviews and product features, presenting them in a format easily understandable to the user. For example, features such as "lightweight and easy to carry," "long battery life," and "clear display" are included in the review. This allows users to easily grasp the product's advantages and disadvantages, facilitating comparison and consideration.

For the notebook computer selected by the user, the order processing unit advances the ordering process through an interactive interface. This interface utilizes chatbots or voice assistants to enable natural conversation with the user. The user can confirm detailed product information and ask additional questions. For example, the system provides appropriate responses to questions such as "What is the warranty period for this product?", "How long will delivery take?", or "What payment methods are available?" Finally, when the user confirms the order, the order processing unit completes the purchase procedure and sends a confirmation email to the user. This email includes the order details, estimated delivery date, payment information, etc. Additionally, the user can view their order history on their device and track the delivery status.

### Application Example 1

The flow of the specific processing in Application Example 1 is described below. Each part of the system described below is implemented by the data processing device 12 and the smart device 14. The data processing device 12 is referred to as the "server," and the smart device 14 is referred to as the "terminal."

### Implementation Examples for the Present Invention

As an embodiment for implementing the present invention, a detailed description follows of a product purchase support system for virtual stores. This system assists users in exploring and purchasing products within a virtual space using VR devices or AR devices.

First, the user interface unit provides an entry point for users to access the virtual store. This interface delivers an immersive shopping experience to users through VR headsets or AR glasses. Users can freely move within the virtual space and visually inspect products. For example, if a user is looking for a jacket, various jackets are displayed within the virtual store, and the user can examine them in detail from a 360-degree perspective. Additionally, users can input information about products using voice commands or gestures. For example, specifying conditions like "red jacket," "waterproof," and "under ¥10,000" will cause the system to display matching products.

Next, the generative AI unit analyzes information input by the user. This unit combines speech recognition technology and natural language processing technology to decompose the user's input into product attributes. For example, the input "red jacket" extracts color and category, the input "waterproof function" extracts function, and the input "under ¥10,000" extracts price range. This enables detailed understanding of the user's needs and allows them to be considered as important factors for product selection.

The analyzed information is sent to the Search Unit, which searches the product database. This database stores detailed information on various products. For example, for jackets, this includes brand, material, size, price, user reviews, and rating scores. The search unit can quickly narrow down matching products based on the specified conditions. Furthermore, search results are presented as personalized recommendations, taking into account the user's past purchase history and browsing history. For example, a user who previously purchased a jacket from a specific brand will have new items from that brand displayed with priority.

For products obtained as search results, the review generation section creates a review summary. This section automatically extracts the product's advantages and disadvantages based on past user reviews and product features, presenting them to the user via voice or text. For example, a review might include characteristics such as "This jacket has high waterproof performance and is lightweight for easy portability." This allows users to easily grasp the product's features and advantages, facilitating comparison and consideration.

For products selected by the user, the order processing unit advances the ordering process through an interactive interface. This interface uses chatbots or voice assistants to enable natural conversation with the user. The user can confirm detailed product information and ask additional questions. For example, the system provides appropriate responses to questions like "What is the warranty period for this product?" "How long does shipping take?", or "What payment methods are available?" The system provides appropriate responses to such questions. Finally, when the user confirms the order, the order processing unit completes the purchase procedure and provides confirmation information to the user. In this way, the present invention aims to enhance the user's purchasing experience in a virtual store and streamline the decision-making process in online shopping.

Furthermore, the user interface unit is equipped with technology to track user movements and ensure smooth navigation within the virtual space. For example, when a user performs a gesture like reaching out to select an item, that action is immediately reflected in the system, displaying detailed information about the selected item. Additionally, using voice commands, users can filter products or search for specific categories. For example, commands like "Show me the latest jackets" or "Display items on sale" enables efficient product exploration.

The generative AI unit learns from the user's past behavior data to make more accurate product recommendations. For example, by analyzing past purchase trends and identifying the user's preferred styles and brands, it can suggest more suitable products for their next shopping session. It can also make recommendations based on season and trends; for instance, it can recommend jackets with high cold-weather performance in winter and jackets with good breathability in summer.

The Search Unit updates the database in real time, instantly reflecting new products and sale information. This allows users to always select products based on the latest information. For example, when new arrivals are in stock, notifications can be sent to users, and priority display within the virtual store can be implemented to increase user purchase motivation.

The review generation unit updates review content based on user feedback, providing more reliable information. For example, when a user posts a review after purchase, reflecting this content and presenting it to other users allows for more accurate communication of the product's evaluation. Additionally, reviews are generated in multiple languages, enabling support for international users.

The order processing unit incorporates a security-focused payment system, enabling safe transactions while protecting user personal information. For example, it uses encryption technology to safeguard payment details and prevent unauthorized access. It also supports multiple payment methods, offering user-friendly options like credit cards, digital wallets, and bank transfers. This allows users to proceed with purchases confidently.

### System Configuration

The system according to this embodiment comprises a user interface unit, a generative AI unit, a search unit, a review generation unit, and an order processing unit. The user interface unit provides an entry point for users to access the virtual store and visually inspect products. This interface delivers an immersive shopping experience to users through VR headsets or AR glasses. Users can freely move within the virtual space and examine them in detail from a 360-degree perspective. For example, if a user is looking for a jacket, various jackets are displayed within the virtual store, allowing the user to visually inspect them. Furthermore, users can input information about products using voice commands or gestures. For instance, by specifying conditions such as "red jacket," "waterproof," and "under ¥10,000," the system displays products matching these criteria.

The Generative AI Unit analyzes information input by the user. This unit combines speech recognition technology and natural language processing technology to decompose the user's input into product attributes. For example, the input "red jacket" extracts color and category; the input "waterproof functionality" extracts functionality; and the input "under ¥10,000" extracts price range. This enables detailed understanding of the user's needs and allows these to be considered as important factors for product selection. A specific example of a prompt sentence fed to the generative AI is: "Based on the conditions specified by the user, extract the product category, color, function, and price range, and decompose them into product attributes."

The search unit searches the product database based on information analyzed by the generative AI unit. This database stores detailed information on various products; for example, for jackets, this includes brand, material, size, price, user reviews, and rating scores. The search unit can quickly narrow down relevant products based on specified conditions. Furthermore, search results include the user's past purchase history and browsing history. The search unit can rapidly narrow down relevant products based on the specified conditions. Furthermore, the search results are presented as personalized recommended products, taking into account the user's past purchase history and browsing history. For example, a user who previously purchased a jacket from a specific brand will have new items from that brand displayed with priority.

The review generation unit generates reviews for products identified by the search unit. This unit automatically extracts the product's advantages and disadvantages based on past user reviews and product features, presenting them to the user via voice or text. For example, a review might include characteristics such as, "This jacket has high waterproof performance and is lightweight for easy portability." This allows users to easily grasp the product's features and advantages, facilitating comparison and consideration.

The Order Processing Unit provides an interactive interface for ordering the products selected by the user. This interface utilizes chatbots or voice assistants to enable natural conversation with the user. Users can confirm product details and ask additional questions. For example, the system provides appropriate responses to questions such as "What is the warranty period for this product?", "How long does delivery take?", or "What payment methods are available?" Finally, when the user confirms the order, the order processing unit completes the purchase procedure and provides confirmation information to the user. In this way, the system according to this embodiment enhances the user's purchasing experience in the virtual store and streamlines the decision-making process in online shopping.

### (Implementation Steps)

### Step 1: User Information Input

The user wears a VR or AR device and accesses the virtual store. Through the user interface, the user inputs information about the desired product. For example, the user specifies conditions such as "red jacket," "waterproof," and "under ¥10,000" using voice commands or gestures. This allows the user to communicate specific needs to the system. The user can freely move within the virtual space and examine products in detail from a 360-degree perspective.

### Step 2: Information Analysis

Information input by the user is analyzed by the generative AI unit. In this step, combines speech recognition and natural language processing technologies to decompose the user's input into product attributes. For example, the input "red jacket" yields color and category, "waterproof functionality" yields functionality, and "under ¥10,000" yields price range. A specific example of a prompt sentence fed to the generative AI is: "Based on the user's specified conditions, extract the product category, color, function, and price range, and decompose them into product attributes."

### Step 3: Product Search

The analyzed information is sent to the search unit, which searches the product database. This database stores detailed information on various products; for example, for jackets, it includes brand, material, size, price, user reviews, and rating scores. The search unit can quickly narrow down matching products based on the specified conditions. Furthermore, search results are presented as personalized recommended products, taking into account the user's past purchase history and browsing history.

### Step 4: Review Generation

Reviews for products identified by the search unit are generated by the review generation unit. This unit automatically extracts the product's advantages and disadvantages based on past user reviews and product features, presenting them to the user via voice or text. For example, a review might include characteristics such as, "This jacket has high waterproof performance and is lightweight for easy portability." This allows users to easily grasp the product's features and advantages, facilitating comparison and consideration.

### Step 5: Order Processing

An interactive interface is provided for the user to order the selected product. This interface uses chatbots or voice assistants to enable natural conversation with the user. The user can confirm product details and ask additional questions. For example, the system provides appropriate responses to questions like "What is the warranty period for this product?" or "How long does shipping take?" "What payment methods are available?" The system provides appropriate responses to such questions. Finally, when the user confirms the order, the order processing unit completes the purchase procedure and provides confirmation information to the user.

### Specific Use Cases

For example, when a user wants to purchase new sports shoes, they wear a VR device and access a virtual store. Using voice commands via the user interface unit, they specify conditions such as "lightweight running shoes," "good ventilation," and "budget under ¥10,000." This allows the user to convey their specific needs to the system.

The generative AI unit analyzes the user's input and decomposes it into product attributes. For example, the input "lightweight running shoes" yields the category and function attributes; "good ventilation" yields the characteristic attribute; and "under ¥10,000" yields the price range attribute. A specific example of a prompt sentence fed to the generative AI is: "Based on the user's specified conditions, extract the product category, function, characteristics, and price range, and decompose them into product attributes."

The analyzed information is sent to the search unit, which searches the product database. This database stores detailed information on various sports shoes, including brand, material, size, price, user reviews, and rating scores. The search unit can quickly narrow down matching products based on the specified conditions. Search results are displayed as 3D models within the user's field of view, allowing the user to inspect the shoes from a 360-degree perspective.

The review generation unit generates reviews for the shoes identified by the search unit. This section automatically extracts the product's advantages and disadvantages based on past user reviews and product features, presenting them to the user via voice or text. For example, reviews might include characteristics such as "These shoes are lightweight and comfortable even during long runs" or "They offer good breathability, preventing feet from getting sweaty even in summer." This allows users to easily grasp the product's features and benefits, facilitating comparison and consideration.

For the shoes selected by the user, the order processing unit advances the ordering process through an interactive interface. Users can use voice commands to check detailed product information and ask additional questions. For example, the system provides appropriate responses to questions like "What is the warranty period for these shoes?", "How long does delivery take?", or "What payment methods are available?" Finally, when the user confirms the order, the order processing unit completes the purchase procedure and provides confirmation information to the user. This approach aims to enhance the user's purchasing experience in the virtual store and streamline the decision-making process for online shopping.

The specific processing unit 290 transmits the results of the specific processing to the smart device 14. On the smart device 14, the control unit 46A instructs the output device 40 to output the results of the specific processing. The microphone 38B acquires audio indicating the user input regarding the results of the specific processing. The control unit 46A transmits the audio data indicating the user input acquired by the microphone 38B to the data processing unit 12. At the data processing unit 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others and can perform various processing tasks, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, which is then processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12, providing the generated cooking menu to the user. The correspondence between each unit and the device or control unit is not limited to the above examples and various modifications are possible.

The above embodiment described a configuration where specific processing is performed by the data processing device 12, but the technology disclosed herein is not limited thereto; specific processing may also be performed by the smart device 14.

### Second Embodiment

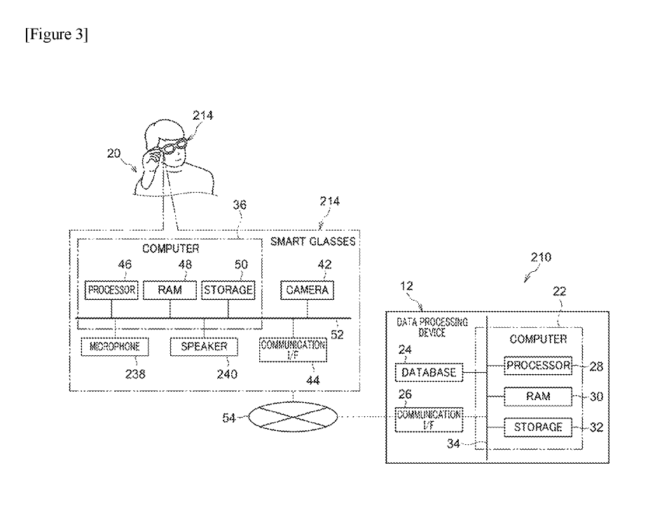

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

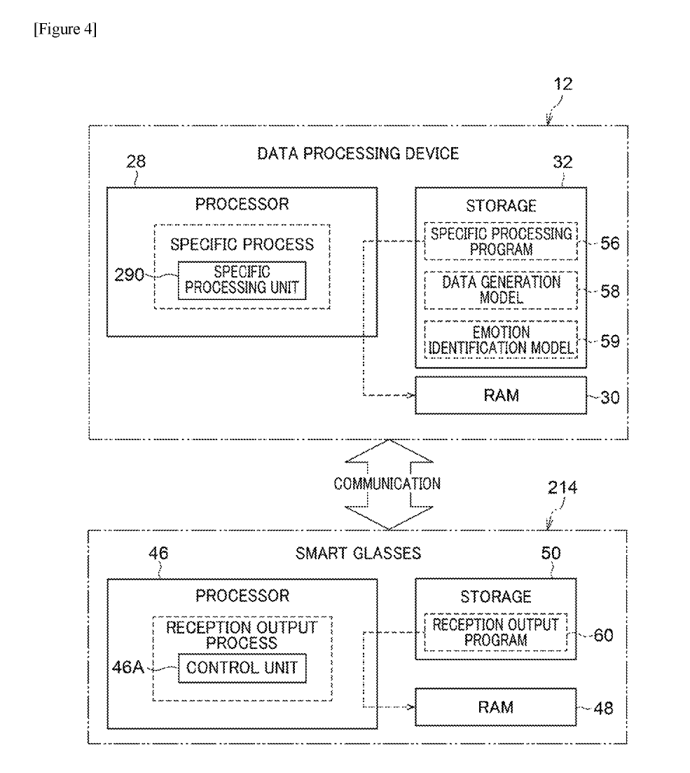

FIG. 4 shows an example of the main functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the above first embodiment is the same, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet). Search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others and can perform various processing tasks, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

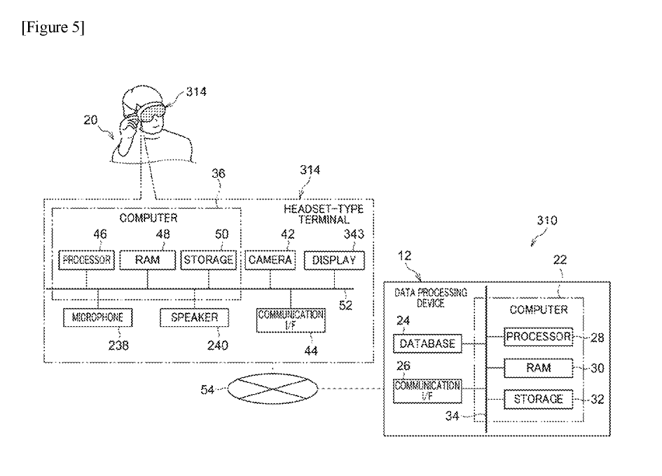

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

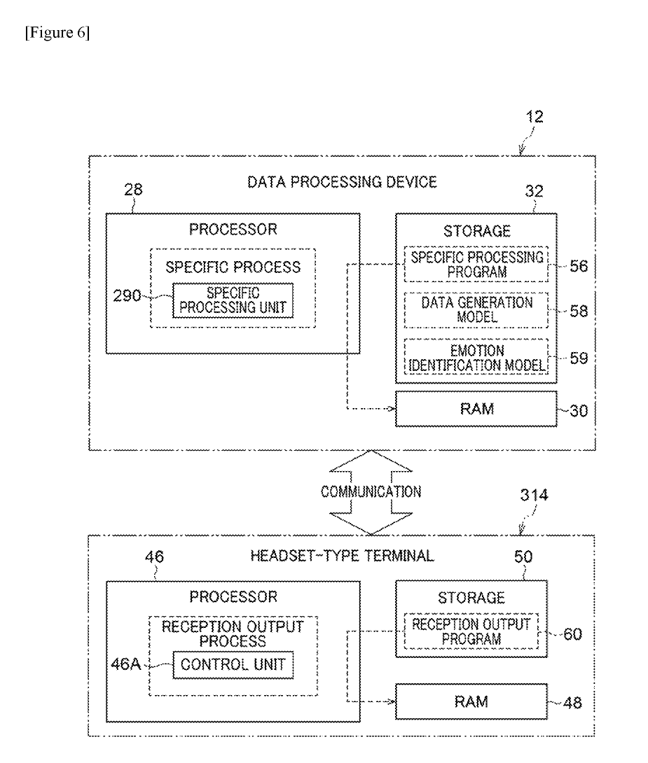

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like include multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNNs), recurrent neural networks (RNN), generative adversarial networks (GAN), or naive Bayes, among others and can perform various processing tasks, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

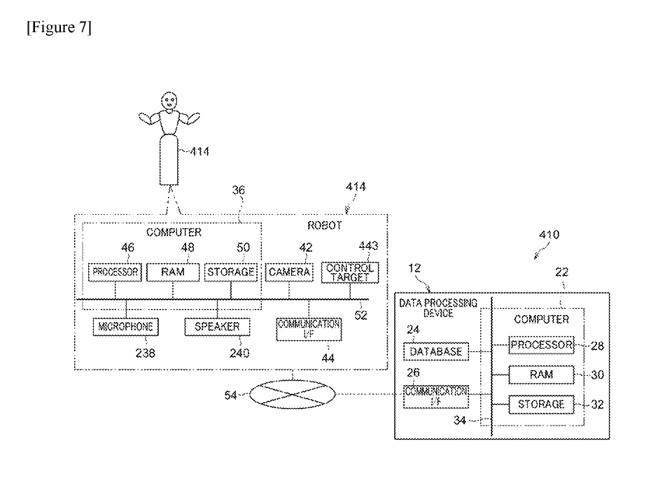

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Microphone 238, speaker 240, camera 42, and controlled object 443 are also connected to bus 52.

Microphone 238 receives voice commands from user 20 by capturing the user's spoken audio. Microphone 238 captures the audio emitted by user 20, converts the captured audio into audio data, and outputs it to processor 46. Speaker 240 outputs audio according to instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

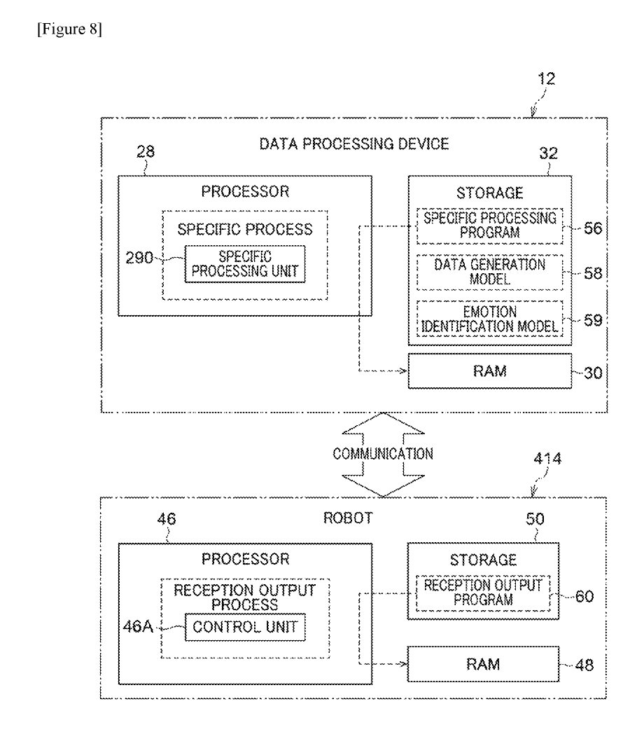

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the explanation is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others and can perform various processing tasks, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, which is then processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

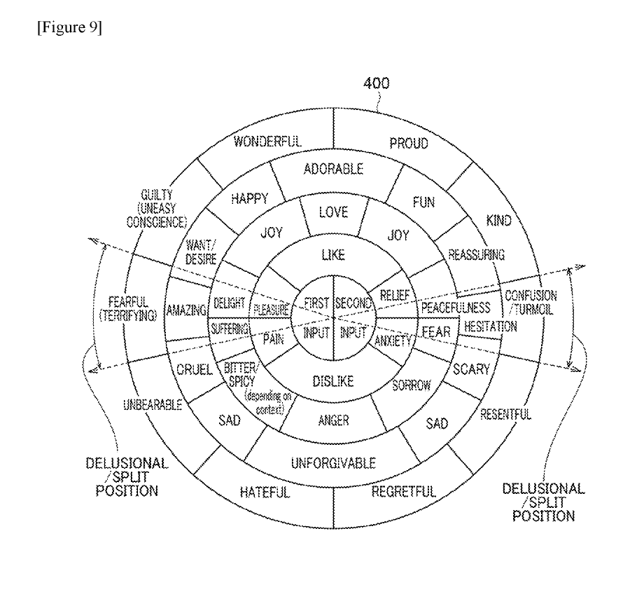

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents actions. Therefore, the further outward one goes on the emotion map 400, the more visible the emotion becomes (manifesting in actions).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. The emotion map is, for example, Dr. Mitsuyoshi's Emotion Map (Based on research on speech emotion recognition and brain physiological signal analysis systems for emotions, Tokushima University, doctoral dissertation: https://ci.nii.ac.jp/naid/500000375379). The left half of the emotional map displays emotions belonging to the "Reaction" domain, where sensory perception predominates. The right half displays emotions belonging to the "Situation" domain, where situational awareness predominates.

Two emotions that promote learning are defined in the emotion map. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

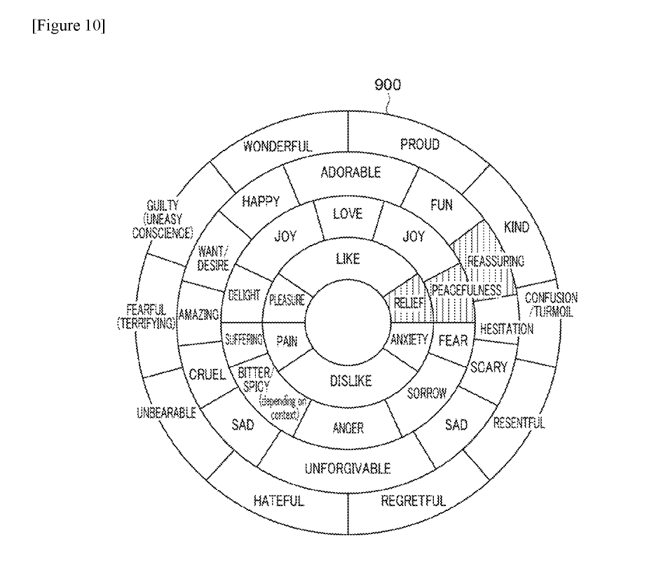

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in Emotion Map 900 in FIG. 10, have similar values. FIG. 10 illustrates an example where multiple emotions, such as "reassurance," "tranquility," and "confidence," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone or the like. The method of the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited thereto. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors may be used as hardware resources for executing the specific processing. Examples of processors include general-purpose processors (CPUs) that function as hardware resources for executing specific processing by executing software, i.e., programs. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by a combination of one or more CPUs and software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects of the part pertaining to the technology of this disclosure. Therefore, it goes without saying that within the scope not deviating from the main purpose of the technology of this disclosure, unnecessary parts may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure have been omitted from the above descriptions and illustrations.

All references, patent applications, and technical specifications cited herein are incorporated by reference to the same extent as if each reference, patent application, and technical specification were specifically and individually cited herein.

Regarding the above embodiments, the following is further disclosed.

### Supplementary Note 1

A system comprising a user interface unit, a generative AI unit, a search unit, a review generation unit, and an order processing unit. The user interface unit provides an interface for visually confirming products within a virtual store using VR or AR devices and for inputting information related to products using voice or gestures. The generative AI unit analyzes information input by the user and decomposes it into product attributes using natural language processing technology. The search unit searches a product database based on the analyzed information. The order processing unit processes orders based on the results of the search unit. The generative AI unit analyzes information input by the user and decomposes it into product attributes using natural language processing technology. The search unit searches the product database based on the analyzed information and identifies products matching the conditions. The review generation unit generates a summary of reviews for the identified products and presents it to the user. The order processing unit provides an interactive interface for ordering the products selected by the user and completes the purchase procedure.

The user interface unit enables users to view products from a 360-degree perspective within a virtual space and input product-related information using voice commands or gestures, as described in Supplementary Note 1. The generative AI unit combines speech recognition technology and natural language processing technology to decompose user input into attributes such as product category, color, function, and price range, considering them as key factors for product selection.

The review generation unit automatically extracts product advantages and disadvantages based on past user reviews and product features, presenting them to the user via voice or text, as described in Supplementary Note 1. The order processing unit uses voice commands or gestures to confirm product details, provides appropriate responses to additional questions, and upon the user's final order confirmation, completes the purchase process and provides confirmation information to the user.

### Symbol Explanation

10, 210, 310, 410 Data Processing System

12 Data Processing Device

14 Smart Device

214 Smart Glasses

314 Headset-type devices

414 Robot

What is claimed is:

1. A distributed product purchasing support system comprising:
a user terminal including;
a processor,
a memory storing a reception output program,
a microphone configured to receive voice input,
a display configured to present visual information, and
a communication interface; and
a server including;
a processor,
a memory storing a specific processing program,
a product database storing, for each product, structured product records including at least: product category, manufacturer, specifications, price, user review data, and rating score, and
a communication interface coupled to the user terminal over a network;
wherein the server processor is configured to execute the specific processing program to:
receive natural-language product-related input from the user terminal;
input the natural-language product-related input into a generative AI model stored in the memory and implemented as a neural network trained to decompose the natural-language input into a structured attribute set including at least product category, price range, and at least one functional feature;
convert the structured attribute set into database query parameters;
execute a constrained search of the product database using the query parameters to identify a subset of products satisfying all extracted attributes;
generate, using a machine learning model distinct from the generative AI model, a review summary for each product in the subset by automatically extracting advantages and disadvantages from the stored user review data;
rank the subset of products based on a composite score including attribute match degree and rating score; and
transmit ranked products and corresponding generated review summaries to the user terminal for interactive selection and ordering.

2. The system of claim 1, wherein the generative AI model comprises a fine-tuned neural network trained using supervised learning on training data including pairs of natural-language product descriptions and corresponding structured attribute sets.

3. The system of claim 1, wherein the structured attribute set further includes at least one of: manufacturer, place of origin, brand, material, size, or performance specification extracted from the natural-language input.

4. The system of claim 1, wherein the server processor is further configured to calculate an attribute match score representing a degree of correspondence between extracted attributes and product record fields, and wherein the composite score includes the attribute match score.

5. The system of claim 1, wherein the review summary is generated by performing sentiment classification on stored user review data and extracting text segments classified as positive and negative sentiment.

6. The system of claim 1, wherein the order processing includes encrypting payment information using an encryption protocol prior to completing a purchase transaction.

7. A product purchasing support system comprising:
a user interface device including a microphone configured to receive user voice input;
a server including a processor and memory storing;
a generative AI model;
an emotion identification model implemented as a neural network; and
a product database storing structured product records;
wherein the server processor is configured to:
analyze user voice input to extract product-related conditions using the generative AI model;
determine a user emotional state by inputting the user voice input into the emotion identification model to obtain emotion values mapped to a multidimensional emotion map;
search the product database based on the extracted product-related conditions;
rank retrieved products using a ranking function that is dynamically modified based on the determined emotional state; and
transmit ranked product information to the user interface device.

8. The system of claim 7, wherein the emotion identification model outputs a multidimensional emotion vector corresponding to positions on an emotion map comprising concentric regions representing primitive emotional states and outer regions representing action-oriented states.

9. The system of claim 7, wherein the emotional state is determined using extracted audio features including at least pitch, amplitude, and speech rate.

10. The system of claim 7, wherein, when the emotional state corresponds to an anxiety-related region of the emotion map, a weighting factor for rating score is increased in the ranking function.

11. The system of claim 7, wherein, when the emotional state corresponds to a confidence-related region, a weighting factor for newly released products is increased.

12. The system of claim 7, wherein system response content is modified in tone or detail level based on the determined emotional state.

13. A virtual product exploration and purchasing system comprising:
a head-mounted display device including
a camera configured to capture a user field of view,
a microphone configured to receive voice commands,
a display configured to render three-dimensional product models in a virtual space, and
a communication interface; and
a server including a processor, memory storing a generative AI model, and a product database;
wherein the server processor is configured to:
receive voice commands specifying product conditions including at least product category and price range;
decompose the voice commands into structured product attributes using speech recognition combined with natural language processing;
retrieve products matching the structured attributes from the product database;
transmit three-dimensional product model data corresponding to retrieved products; and
wherein the head-mounted display device is configured to:
render the three-dimensional product models in the virtual space enabling 360-degree inspection; and
detect gesture-based selection input to initiate an order process.

14. The system of claim 13, wherein gesture-based selection input is detected by recognizing a predefined hand motion pattern using the camera.

15. The system of claim 13, wherein the transmitted product model data includes spatial metadata enabling scaling and rotation of the product model within the virtual space.

16. The system of claim 13, wherein products are displayed with priority based on user purchase history stored in the server memory.

17. The system of claim 13, wherein the product database is updated in real time to reflect newly registered products or inventory changes prior to retrieval.

18. The system of claim 13, wherein the head-mounted display device is a VR headset or AR glasses configured to render an immersive virtual store environment.
